(19) United States
(12) Patent Application Publication
(10) Pub. No.: US 2013/0331145 A1
(43) Pub. Date: Dec. 12, 2013

(54) MEASURING SYSTEM FOR MOBILE THREE DIMENSIONAL IMAGING SYSTEM

(71) Applicants: Miao LIAO, Camas, WA (US); Chang YUAN, Vancouver, WA (US)

(72) Inventors: Miao LIAO, Camas, WA (US); Chang YUAN, Vancouver, WA (US)

(73) Assignee: SHARP LABORATORIES OF AMERICA, INC., Camas, WA (US)

(21) Appl. No.: 13/491,290

(22) Filed: Jun. 7, 2012

(51) Int. Cl. H04N 13/02; H04W 88/02

(52) U.S. Cl. 455/556.1; 348/E13.074

(57) ABSTRACT

A mobile device including an imaging device with a display and capable of obtaining a pair of images of a scene having a disparity between the pair of images. The imaging device estimating the distance between the imaging device and a point in the scene indicated by a user on the display. The imaging device displaying the scene on the display.

### CROSS-REFERENCE TO RELATED APPLICATIONS

None.

### BACKGROUND OF THE INVENTION

Many mobile devices, such as cellular phones and tablets, include cameras to obtain images of scenes. Such mobile devices are convenient for acquiring images since they are frequently used for other communications, the image quality is sufficient for many purposes, and the acquired image can typically be shared with others in an efficient manner. The three dimensional quality of the scene is apparent to the viewer of the image, while only two dimensional image content is actually captured.

Other mobile devices, such as cellular phones and tablets, with a pair of imaging devices are capable of obtaining images of the same general scene from slightly different viewpoints. The acquired pair of images obtained from the pair of imaging devices of generally the same scene may be processed to extract three dimensional content of the image. Determining the three dimensional content is typically done by using active techniques, passive techniques, single view techniques, multiple view techniques, single pair of images based techniques, multiple pairs of images based techniques, geometric techniques, photometric techniques, etc. In some cases, object motion is used to for processing the three dimensional content. The resulting three dimensional image may then be displayed on the display of the mobile device for the viewer. This is especially suitable for mobile devices that include a three dimensional display.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a mobile device with a pair of imaging devices.

FIG. 2 illustrates image processing.

FIG. 3 illustrates a three dimensional image processing technique.

FIG. 4 illustrates a horizontal line and an object.

FIG. 5 illustrates a noise reduction technique.

FIG. 6 illustrates a pixel selection refinement technique.

FIG. 7 illustrates a matching point selection technique.

FIG. 8 illustrates a sub-pixel refinement matching technique.

FIG. 9 illustrates a graphical sub-pixel refinement technique.

FIG. 10 illustrates a three dimensional triangulation technique.

FIG. 11 illustrates a graphical three dimensional selection technique.

### DETAILED DESCRIPTION OF PREFERRED EMBODIMENT

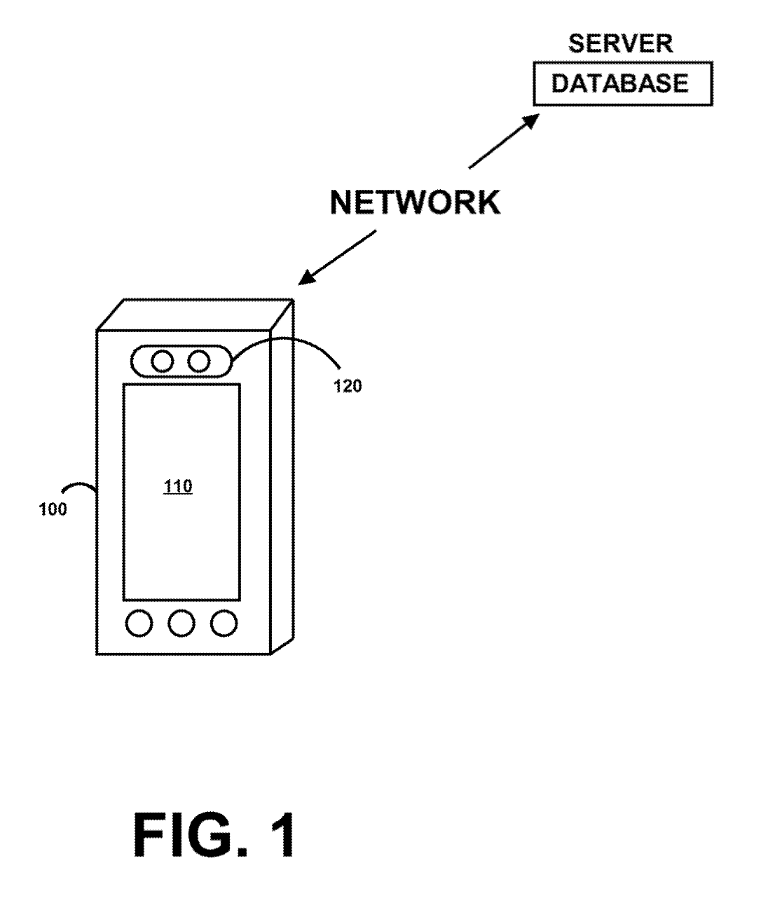

Referring to FIG. 1, a mobile device 100 such as a cellular device or tablet, may include display 110 incorporated therewith that is suitable for displaying images thereon. In addition, the mobile device may include a keyboard for data entry, such as a physical keyboard and/or a virtual on-screen keyboard. The mobile device may include one or more imaging devices 120 with one or more lenses, together with associated circuitry to acquire at least a pair of images from which a stereoscopic scene can be determined.

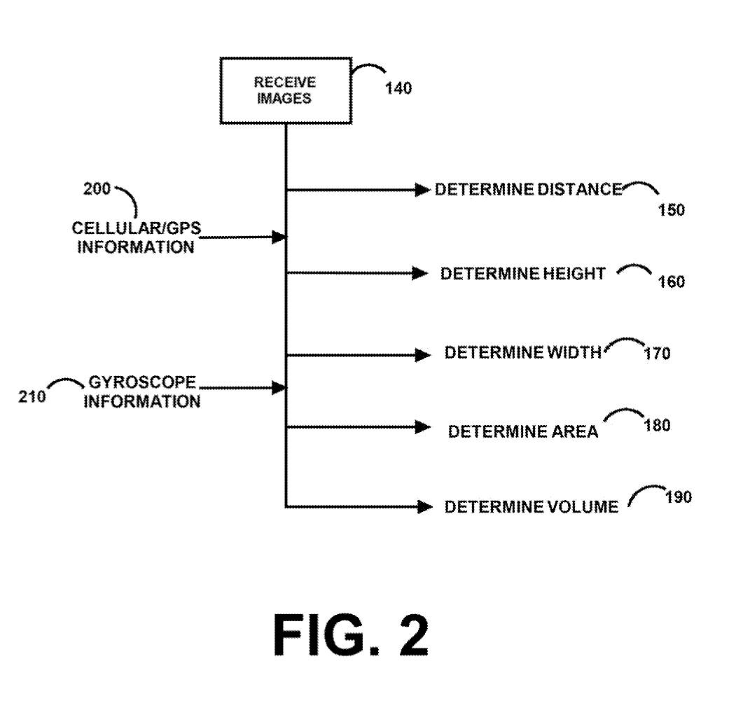

Referring to FIG. 2, the mobile device may include software (or otherwise) that processes a pair of images 140 acquired from the imaging device (including one or more image capture devices) to obtain stereoscopic image data which may be used for further applications or otherwise for presentation on the display. Preferably, the display 110 is a stereoscopic display. Based upon the image content obtained, the mobile device may determine properties of the scene, such as for example, the distance to one or more points in the scene 150, the height of one or more objects in the scene 160, the width of one or more objects in the scene 170, the area of one or more objects in the scene 180, and/or the volume of one or more objects in the scene 190. To further refine the determined properties, the mobile device may make use of GPS information 200 in making determinations and/or gyroscope information 210 in making determinations. Further, by having such functionality included together with a mobile device it is especially versatile and portable, being generally available when the mobile device is available.

While the determination of one or more properties of a three-dimensional scene by a mobile device is advantageous, it is further desirable that the selection of the determination be suitable for a pleasant user experience. For example, the user preferably interacts with a touch screen display on the mobile device to indicate the desired action. In addition, the mobile device may include two-way connectivity to provide data to, and receive data in response thereto, a server connected to a network. The server may include, for example, a database and other processing capabilities. In addition, the mobile device may include a local database together with processing capabilities.

The three dimensional characteristics of an image may be determined in a suitable manner. The mobile device typically includes a pair of cameras which have parallel optical axes and share the same imaging sensor. In this case, the three-dimensional depth) (Z^{3D}) is inversely proportion to the two-dimensional disparity (e.g., disp). With a pair of cameras having parallel optical axes (for simplicity purposes) the coordinate system may be referenced to the left camera. The result of the determination is an estimated depth of the position P in the image. The process may be repeated for a plurality of different points in the image. In another embodiment the mobile device may use a pair of cameras with non-parallel camera axes. The optical axes of the cameras are either converging or diverging. The 3D coordinates of the matched image points are computed as intersection point of 3D rays extended from the original 2D pixels in each image. This process may be referred to as “triangulation”. The three dimensional coordinates of the object of interest (namely, x, y, and z) may be determined in any suitable manner. The process may be repeated for a plurality of different points in the image. Accordingly, based upon this information, the distance, length, surface area, volume, etc. may be determined for the object of interest.

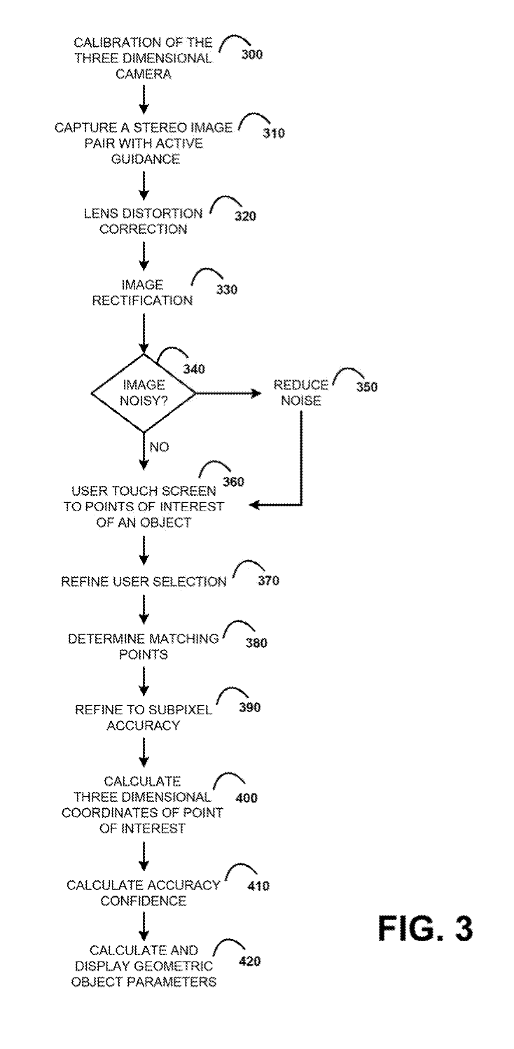

Referring to FIG. 3, an exemplary embodiment of the three dimensional imaging system is illustrated where the user assists in the selection of the point(s) and/or object(s) of interest. Preferably, the three dimensional camera is calibrated 300 in an off-line manner. The calibration technique 300 may be used to estimate intrinsic camera parameters (e.g., focal length, optical center, and lens distortion) and estimate extrinsic camera parameters (e.g., relative three dimensional transformation between imaging sensors). The calibration technique may use, for example, a calibration target (e.g., checkerboard), from which two dimensional corner points are determined, and thus camera parameters.

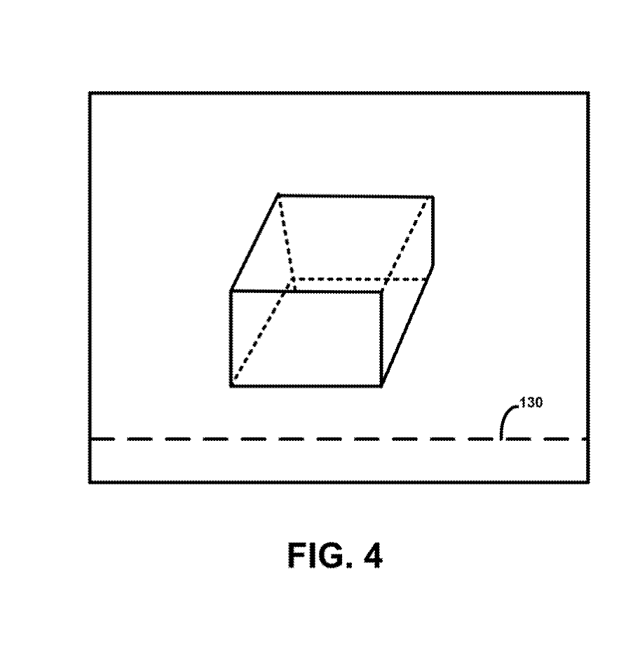

The user of the mobile device may capture a stereo image pair with active guidance 310 that includes the object of interest. Referring to FIG. 4, the preview image on a display 110 of the mobile device 100 may include a horizontal line 130 or any other suitable indication that the user should align with the object of interest. The horizontal line 130 preferably extends a major distance across the display and is preferably offset toward the lower portion of the display. A sufficiently long horizontal line being offset on the display is more suitable for aligning with the object of interest by the user. Using such a horizontal line (or other alignment indication) tends to encourage the user to align the mobile imaging device with the object in a more orthogonal manner. In addition, using such a horizontal line (or other alignment indication) tends to encourage the user to move a suitable distance from the object so that the object has a suitable scale that is more readily identified. Moreover, the guidance line also increases the measurement accuracy because the measurement accuracy depends on the object-camera distance. In general, the closer the camera is to the object, the more accurate the measurement. Preferably, the location of the object with respect to the horizontal line 130, or otherwise, is not used for the subsequent image processing. Rather, the horizontal line 130 is merely a graphical indication designed in such a manner to encourage the user to position the mobile device at a suitable distance and orientation to improve the captured image.

In many cases, the camera functionality of the mobile device may be operated in a normal fashion to obtain pictures. However, when the three dimensional image capture and determination feature is instigated, the active guidance 310 together with the horizontal line 130 is shown, which is different in appearance than other markings that may occur on the screen of the display during normal camera operation.

Referring again to FIG. 3, lens distortion from a pair of captured images may be reduced 320 by applying a non-linear image deformation based on estimated distortion parameters. In addition, the undistorted stereo pair of images may be further rectified by a perspective transformation 330 (e.g., two-dimensional homography) such that corresponding pixels in each image lie on the same horizontal scan line. Corresponding pixels being aligned on the same horizontal scan line reduces the computational complexity of the further image processing.

Typically, the imaging sensors on mobile devices have a relatively small size with high pixel resolution. This tends to result in images with a substantial amount of noise, especially in low light environments. The high amount of image noise degrades the pixel matching accuracy between the corresponding pair of images, and thus reducing the accuracy of the three dimensional position estimation. To reduce the noise, the system checks if the image is noisy 340, and if sufficiently noisy, a noise reduction process 350 is performed, using any suitable technique. Otherwise, the noise reduction process 350 is omitted. The noise reduction technique may include a bilateral filter. The bilateral filter uses an edge preserving (and texture) filter and noise reducing smoothing filter. The intensity value at each pixel in an image is replaced by a weighted average of intensity values of nearby pixels. This weight may be based on a Gaussian distribution. The weight may depend not only on the Euclidean distance but also on radiometric differences (differences in the range, e.g., color intensity). This preserves sharp edges by systematically looping through each pixel and according weights to the adjacent pixels accordingly.

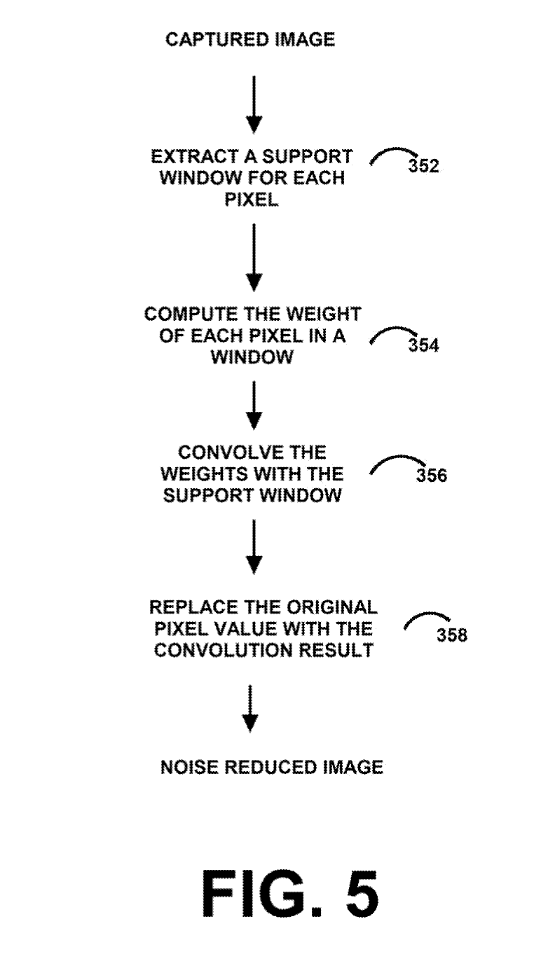

Referring to FIG. 5, one implementation of the noise reduction process 350 that receives the captured image and provides the noise reduced image, may include extracting a support window for each pixel 352. The weights of each pixel in the window are computed 354. The weights 354 are convolved with the support window 356. The original pixel value is replaced with the convolution result 358. In this manner, the weight of the pixels in a support window of pixel p may be computed as:

$${w}_{p} = \frac{1}{{w}_{p}} {\sum }_{q ∈ S} {G}_{{σ}_{s}} ( ‖ p - q ‖ ) {G}_{{σ}_{s}} ( \vert {I}_{p} - {I}_{q} \vert )$$

where p and q are spatial pixels locations, and Iₚ and I_{q} are pixel values of pixels p and q, G is a Gaussian distribution function, and Wₚ is a normalization factor. The new value for pixel p may be computed as

I_{q}=Σ_{qεS}w_{q}I_{q}

After the noise reduction process 350, if applied, the user may touch the screen to identify the points of interest of the object 360. When a user's finger touches the screen, it is preferable that a magnified view of the current finger location is displayed. Since the pixel touched by the finger may not be the exact point that the user desired, it is desirable to refine the user selection 370 by searching a local neighborhood around the selected point to estimate the likely most salient pixel. The most salient points based upon the user-selected pixels are preferably on object edges and/or object corners. The matching point in the other view is preferably computed by using a disparity technique.

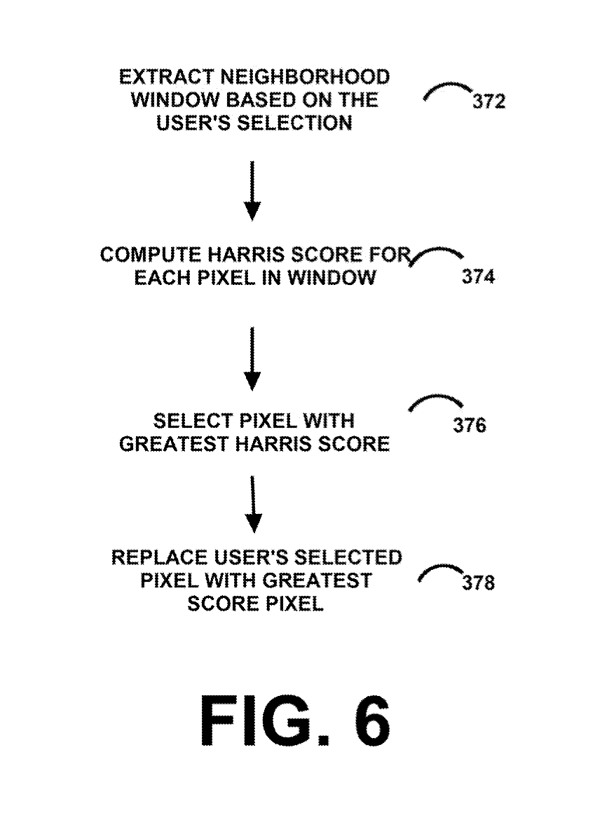

Referring to FIG. 6, the saliency of the pixels may be determined by extracting a neighborhood window 372 based upon the user's selection. A statistical measure may be determined based upon the extracted neighborhood window 372, such as computing a score using a Harris Corner Detector for each pixel in the window 374. The Harris Corner Detector can compute a score for a pixel based on the appearance of its surrounding image patch. Intuitively, an image patch that has a more dramatic variation tends to provide a higher score. The Harris Corner Detector may compute the appearance change if the patch is shifted by [u,v] using the following relationship:

E(u, v)=Σ_{x,y}w(x, y)[I(x+u, y+v)−i(x, y)]²

where w(x,y) is a weighting function, and l(x,y) is an image intensity. By Taylor series approximation, E may be for example,

$$E ( u , v ) ≅ [ u , v ] M [ \frac{u}{v} ]$$

where M is a 2×2 matrix computed from image derivates, for example,

$$M = {\sum }_{x , y} w ( x , y ) [ \begin{matrix}{I}_{x}^{2} & {I}_{x} {I}_{y} \\ {I}_{x} {I}_{y} & {I}_{y}^{2}\end{matrix} ] .$$

The score of a pixel may be computed as

S=det(M)−k(trace(M))² where k is an empirically determined constant between 0.04 and 0.06.

The pixel with the greatest maximum score 376 is selected to replace the user's selected point 378.

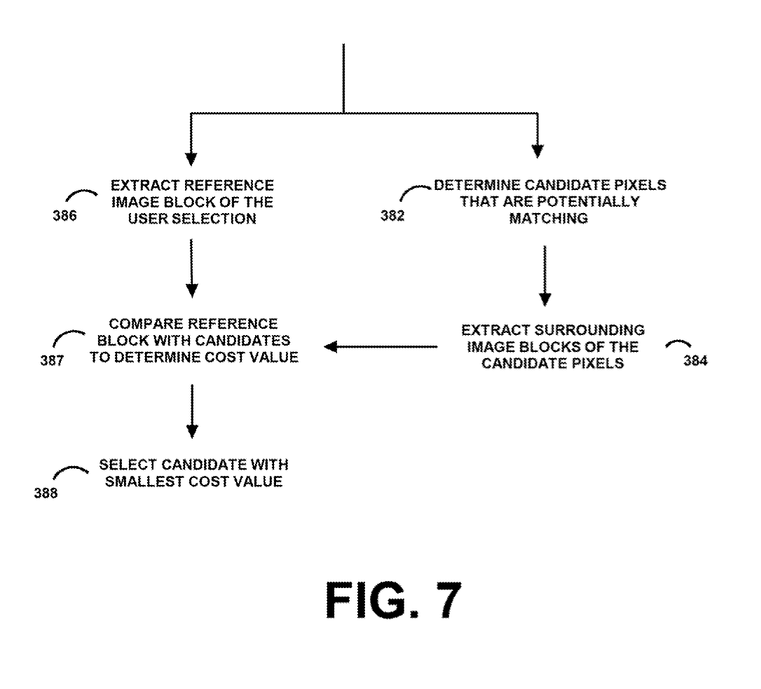

Based upon the identified points, as refined, the system may determine the matching points 380 for the pair of images, such as given one pixel in the left image, xₗ, a matching technique may find its corresponding pixel in the right image, xᵣ. Referring to FIG. 7, one technique to determine the matching points 380 is illustrated. For a particular identified pixel in a first image such as the left image, the system determines candidate pixels that are potentially matching 382 in the other image, such as the right image. The candidate pixels are preferably on the same scan line in both images, due to the previous rectification process, and accordingly the search for candidate pixels preferably only searches the same corresponding scan line. For example, if the selected pixel is in the left image, then the potential candidate pixels are the same location as or to the left of the corresponding pixel location in the right image. Pixel locations to the right of the corresponding pixel location do not need to be searched since such a location would not be correct. This reduces the area that needs to be searched. The same technique holds true if the images are reversed. Surrounding image blocks are extracted based upon the candidate pixels 384 of the other image, such as an image block for each candidate location of the right image. A reference image block is extracted from the selected image 386 based upon the user's selection, such as the left image.

The extracted reference block 386 is compared with the candidate image blocks 384 to determine a cost value associated with each 387, representative of a similarity measure. The candidate with the smallest cost value is selected 388 as the corresponding pixel location in the other image. The disparity d may be computed as d=xᵢ−xᵣ.

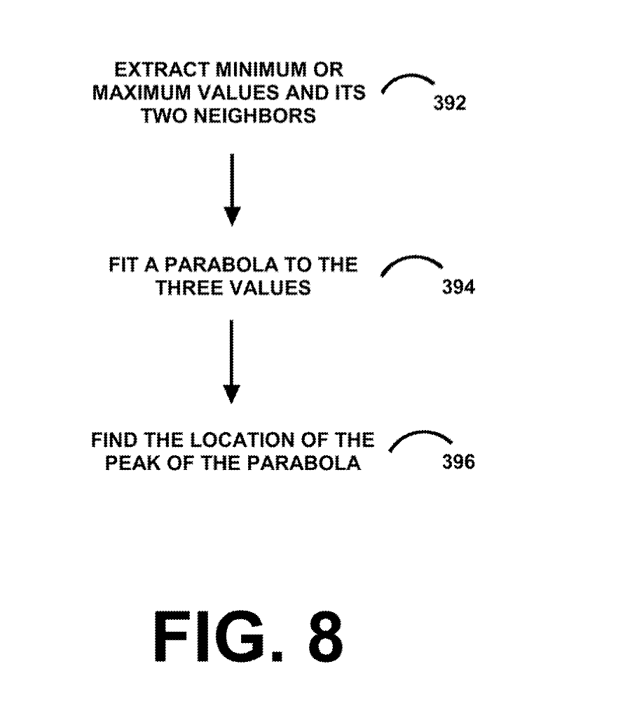

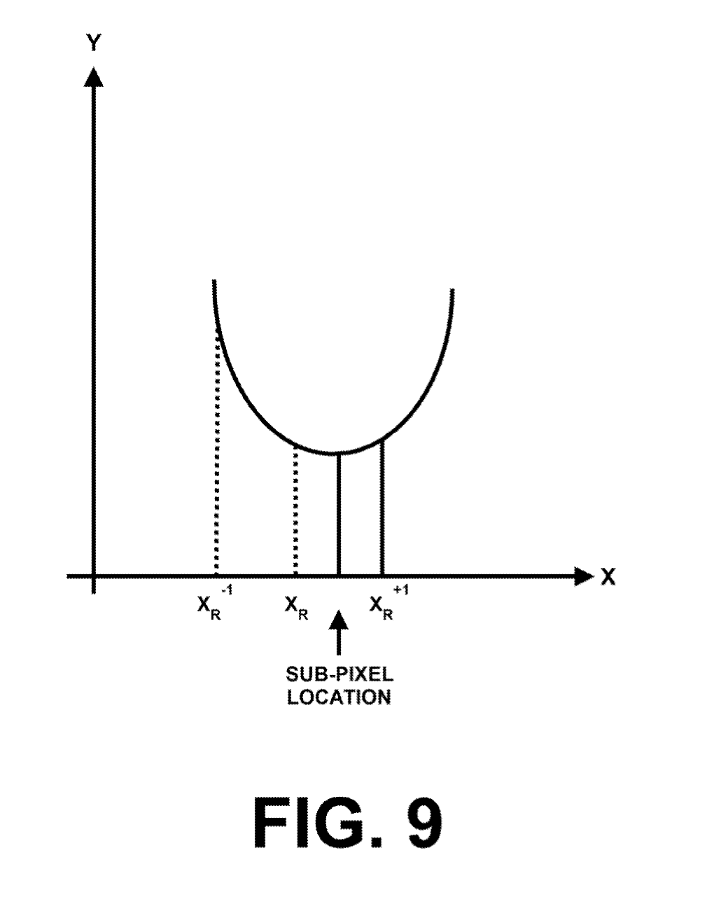

The quantitative accuracy of three dimensional measurements is that the error of the estimated depth is proportional to the square of the absolute depth value and the disparity error, and thus additional accuracy estimation of the disparity is desirable. The location of the matching point 380 may be further modified for sub-pixel accuracy 390. Referring also to FIG. 8 and FIG. 9, the minimum or maximum value, and its two neighbors, are extracted 392. A parabola is fitted to the three extracted values 394. The location of the peak of the parabola is determined 396. The peak is thus used to select the appropriate sub-pixel.

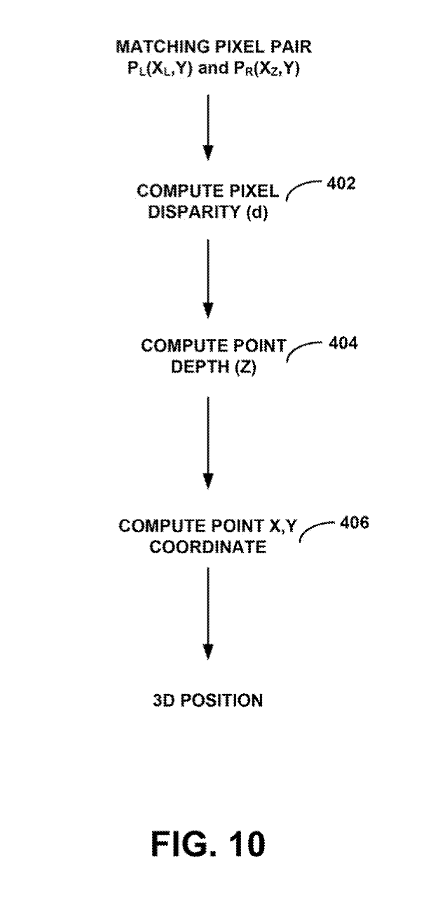

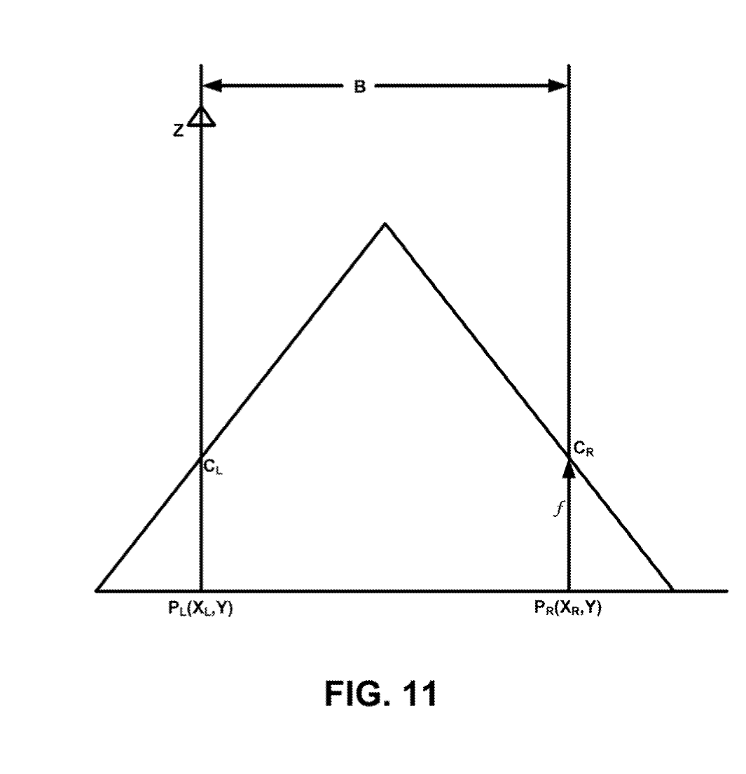

The three dimensional coordinates of the identified points of interest are calculated 400. Referring to FIG. 10, the pixel disparity (d) is computed 402 from a matched pixel pair p_{L}(xₗ,y) and p_{R}(x_{R},y) as the difference between the pixel pair. The point depth (z) of the point is computed 404, which is inversely proportional to its disparity. The X, Y coordinates of the three dimensional point may be computed 406 using a suitable technique, such as using a triangular relationship as follows:

$${x}_{L} = \frac{f}{z} ( X - \frac{B}{2} ) , {x}_{L} - d = \frac{f}{z} ( X + \frac{B}{2} ) -> Z = \frac{f B}{d} -> X = \frac{{Zx}_{L}}{f} + \frac{B}{2} , Y = \frac{Zy}{f}$$

where B is a baseline length between stereo cameras and f is the focal length of both cameras. Referring to FIG. 11, the three dimensional triangulation technique is illustrated, where C_{L} and C_{R} are camera optical centers.

An accuracy measurement error value of the computed 3D coordinates can be predicted 410 for each measurement and visualized on the image (if desired), to indicate how reliable the estimated 3D coordinate values are. It can be represented as a percentage relative to the original absolute value, e.g., +/−5% of 5 meters. The geometric object parameters may be calculated and displayed 420.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A mobile device comprising:
(a) an imaging device with a display and capable of obtaining a pair of images of a scene having a disparity between said pair of images;
(b) said imaging device displaying said scene on said display together with a graphical indicator suitable for being aligned with an object of interest of said scene when said imaging device is in a guidance mode;
(c) said imaging device estimating the distance between said imaging device and a point in said scene indicated by a user on said display, without using information of said graphical indicator.

2. The mobile device of claim 1 wherein said imaging device includes a pair of image sensors.

3. The mobile device of claim 1 wherein said distance is based upon calibration parameters of said imaging device.

4. The mobile device of claim 1 wherein said graphical indicator includes a horizontal line on said display.

5. The mobile device of claim 4 wherein said horizontal line extends across a majority of the width of said display.

6. The mobile device of claim 5 wherein said horizontal line is below the middle of said display.

7. The mobile device of claim 6 wherein said horizontal line is different in appearance than other graphical indicators displayed on said mobile device when said guidance mode is not activated.

8. The mobile device of claim 1 wherein said pair of images are rectified with respect to one another.

9. The mobile device of claim 8 wherein substantially all corresponding pixels in each image lie on the same horizontal scan line.

10. The mobile device of claim 1 wherein noise in said pair of images are reduced using a bilateral filter.

11. The mobile device of claim 1 wherein said point in said scene is refined based upon a feature determination.

12. The mobile device of claim 11 wherein said feature determination is based upon at least one of object edges and object corners.

13. The mobile device of claim 12 wherein said feature determination is based upon a Harris Corner detector.

14. The mobile device of claim 1 wherein said disparity is determined based upon a comparison of a corresponding image row of said pair of images.

15. The mobile device of claim 14 wherein only a portion of said corresponding image row is compared.

16. The mobile device of claim 15 wherein said disparity is further based upon a sub-pixel modification.
